(19) United States
(12) Patent Application Publication
(10) Pub. No.: US 2026/0203678 A1
(43) Pub. Date: Jul. 16, 2026

(54) METHOD TO DETERMINE QUALITATIVE RESOURCE ALLOCATION FOR HVAC COMPONENT SUSTAINMENT

(71) Applicant: Government of the United States as represented by the Secretary of the Air Force, Wright-Patterson AFB, OH (US)

(72) Inventors: Timothy Frank, USAF Academy, CO (US); Justin White, USAF Academy, CO (US); Josh Aldred, USAF Academy, CO (US); Marcus Catchpole, USAF Academy, CO (US)

(21) Appl. No.: 19/025,029

(22) Filed: Jan. 16, 2025

(51) Int. Cl. F24F 11/38; F24F 11/64

(52) U.S. Cl. CPC G06Q 10/0631; G06Q 10/06395; G06Q 10/20; F24F 11/38; F24F 11/64

(57) ABSTRACT

A method of allocating resources for infrastructure sustainment. The method uses the steps of compiling environmental factors for predetermined locations having component of interest. The degradation of that component over time is also determined, to yield a degradation rate. The environmental factors are correlated with the degradation rates of the various components. A Gini index is used to determine which environmental factor has the greatest impact on a particular component category or location. Resources can then be allocated to that environmental factor, component category and/or component location.

### STATEMENT OF GOVERNMENT INTEREST

The invention described and claimed herein may be manufactured, licensed and used by and for the Government of the United States of America for all government purposes without the payment of any royalty.

### FIELD OF THE INVENTION

The present invention is related to a method for qualitatively allocating resources for HVAC component sustainment, particularly to such a method simultaneously usable at plural locations, particularly to such a method usable with plural types of HVAC components and more particularly to such a method usable with and which simultaneously considers plural environmental factors.

### BACKGROUND OF THE INVENTION

Heating, ventilation, and air conditioning (HVAC) is the application of various technologies to regulate the temperature, humidity, and cleanliness of the air in an enclosed space. The goal is to provide suitable thermal comfort and indoor air quality. The laws of fluid mechanics, thermodynamics, and heat transfer provide the basis for the branch of mechanical engineering known as HVAC system design.

U.S. Pat. No. 808,897 for air conditioning issued to Willis Carrier on Jan. 2, 1906. U.S. Pat. No. 1,085,971 for HVAC humidity control and regulation issued to Willis Carrier on Feb. 13, 1914. The key HVAC players include Carrier Corporation, Daikin Industries, Ltd., Emerson Electric Co., Johnson Controls International plc, Lennox International, Inc. and Trane Technologies.

The HVAC market can be segmented by residential, commercial and industrial systems. And the market can be further segmented by component types including heat pumps, furnaces, unitary heaters, boilers, air purifiers, dehumidifiers, air handlers, ventilation fans, air conditioners, chillers and cooling towers.

The degree of innovation in HVAC systems industry is significant as the industry responds to evolving technological trends and sustainability imperatives. Technological advancements, such as the integration of smart and connected solutions, are reshaping the landscape by enhancing system control, automation, and overall energy efficiency. Innovations in sensor technologies, data analytics and Internet of Things (IoT) connectivity enable predictive maintenance, real-time monitoring, and optimization of HVAC systems. The average life of HVAC systems is about 13 years with proper maintenance according to Straits Research of Maharashtra, India. However, several components in HVAC units, such as filters, motors, refrigerant, coolant, etc., must be replaced or repaired frequently due to their short lifespan and operating life cycle.

The HVAC market is significantly influenced by a complex regulatory landscape, encompassing energy efficiency standards, environmental regulations, and building codes. The 2023 domestic U.S. HVAC market was estimated to be USD 30 billion in 2023 and is projected to grow at a compound annual growth rate (CAGR) of 7.4% from 2024 to 2030 according to Grand View Research of San Francisco, CA Report ID: GVR-3-68038-837-4. The 2023 global HVAC services and maintenance market was at least USD 78 billion according to Ariston of Chicago, IL. The total 2024 HVAC market is estimated to be USD 218 billion according to Benchmark International of Tampa, FL.

Despite an infrastructure market worth hundreds of billions of dollars and a services market worth tens of billions of dollars annually and more than a century of HVAC system technological progress, the progress for HVAC services resource allocation has not kept up. For example, maintenance often occurs on a predetermined schedule according to the perceived need of the particular type of component. Or maintenance may be uniformly deferred based upon budgetary constraints.

But such cookie cutter approaches are far from optimum. A particular component in a moderate environment may withstand less maintenance, or even deferred maintenance, than the same component in a harsher environment. Furthermore, not all harsh environments are equivalent. For example, a component in Duluth, MN faces different environmental challenges than a like component in Miami, FL.

But typical HVAC resource allocation does not take such inevitable and ongoing factors into consideration. Accordingly, it is an object of this invention to provide a method of resource allocation which simultaneously considers HVAC locations, environmental factors and types of components.

### SUMMARY OF THE INVENTION

In one embodiment the invention comprises a method of allocating resources for infrastructure sustainment. The method comprises the steps of: selecting a component and at least one location thereof to be analyzed; assembling infrastructure condition information over at least two spaced apart dates for the at least one location; calculating an infrastructure degradation rate for each piece and/or type of component under consideration; associating the infrastructure degradation rate with spatiotemporal environmental data for each location under consideration; determining at least one environmental feature significantly related to infrastructure degradation and allocating degradation mitigation resources based upon the impact of at least one environmental factor on a particular component, the type of component or location of the component.

### BRIEF DESCRIPTION OF THE DRAWINGS

FIG. 1A is a schematic view of n locations having various types of HVAC components.

FIG. 1B is a chart of exemplary environmental data.

FIG. 2 is a summary flowchart of a method according to the present invention.

FIG. 3 is a chart of inspection data of two component categories at two locations.

FIG. 4 is a detailed chart of the inspection data of FIG. 3.

FIG. 5 is a chart of the data of FIG. 3 showing initial and secondary date inspection data.

FIG. 6 is a chart redacting the last inspection data of FIG. 4 and showing the change in degradation between the initial inspection and secondary inspection.

FIG. 7 is a chart showing the degradation rates of FIG. 6 and redacting all rows where the degradation rate was positive.

FIG. 8 is a chart of the data of FIG. 7 without the redacted data.

FIG. 9 is a chart of exemplary precipitation data and exemplary temperature data for exemplary locations A and B.

FIG. 10 is a chart of the degradation rates and five exemplary environmental factors.

FIG. 11 is a chart showing exemplary degradation rates associated with inspection pairs for HVAC components at location A, the value of five environmental features and the means of the data of FIG. 10.

FIG. 12 is a chart of the mean degradation rates for locations A and B.

FIG. 13 is a chart showing the Gini index for each of the exemplary environmental factors.

FIG. 14 is a schematic representation of three options for resource allocation.

### DETAILED DESCRIPTION OF THE INVENTION

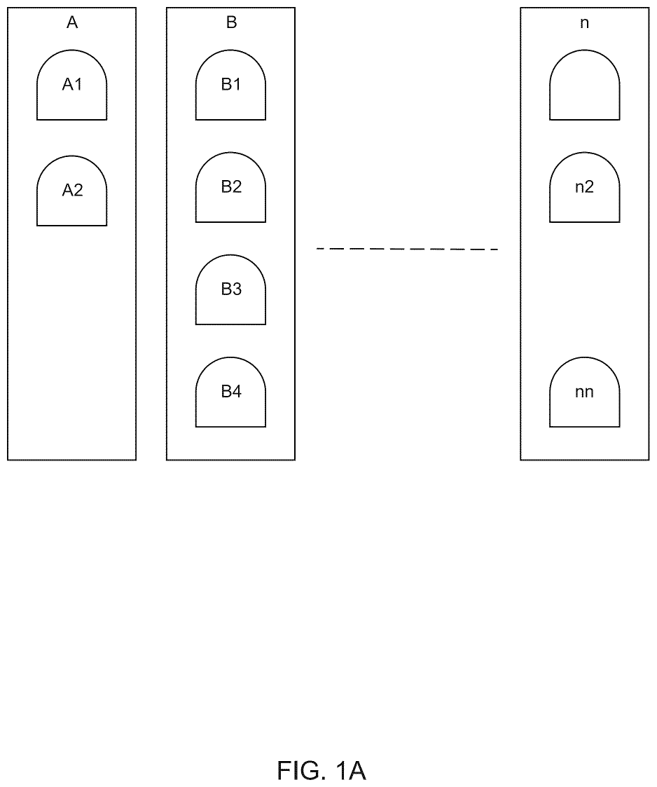

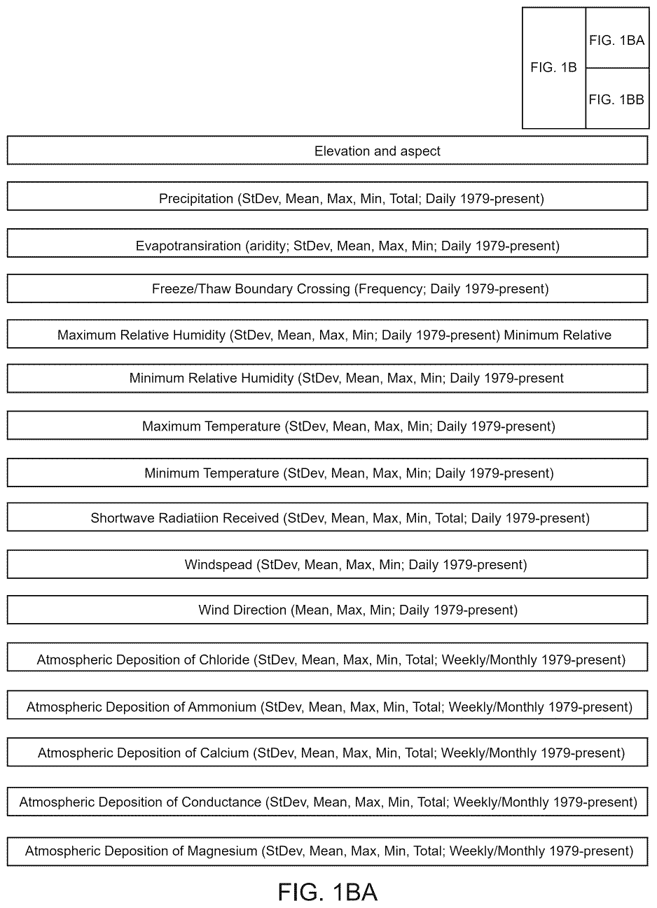

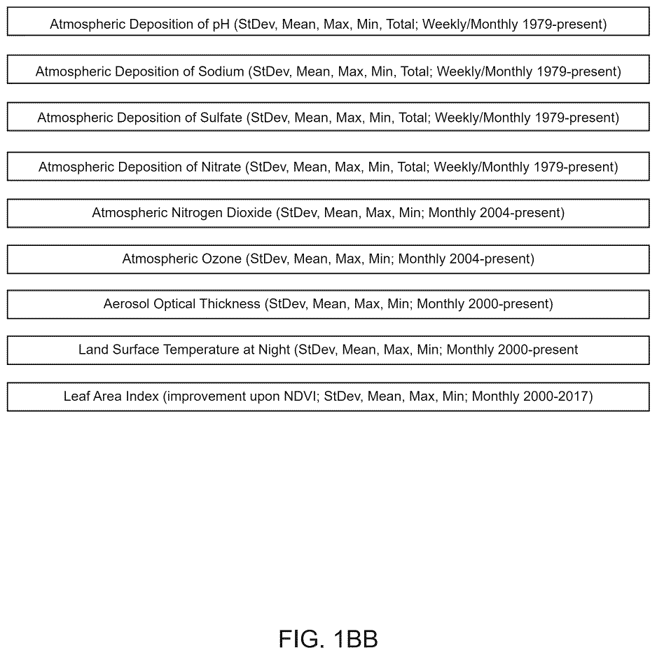

Referring to FIG. 1A, the invention is a method of allocating resources among one or more types of HVAC components at one or more locations. The component is specific as to type, model and location. As set forth above, the HVAC component can include, but not be limited to, a heat pump, furnace, unitary heaters, boiler, air purifier, dehumidifier, air handler, ventilation fan, air conditioner, chiller and/or cooling tower.

Referring to FIG. 1B, the environmental data are spatiotemporal and may include common weather data, chemical deposition, etc. The data are temporal and location based. Environmental factors are uncontrollable and therefore only considered on a lookback basis. Environmental factors are considered on a daily maximum or minimum basis. The lookback period may conveniently go back to 1979 to take advantage of consistent data collection. Alternatively, the lookback period may be shortened to take external factors into account. For example, if a skyscraper was built in 1989 which substantially blocked a component from solar gain or prevailing winds, the environmental data collection may only consider 1989 to present for that specific location. Similarly, if a HVAC component was replaced in 1989, the environmental data collection may only consider 1989 to present for that specific location.

Data for environmental factors may be obtained from the National Trends Network, from the US Geological Survey or local sites if the local data are considered more helpful. One of skill will recognize that the same source should be used throughout a particular execution of this method.

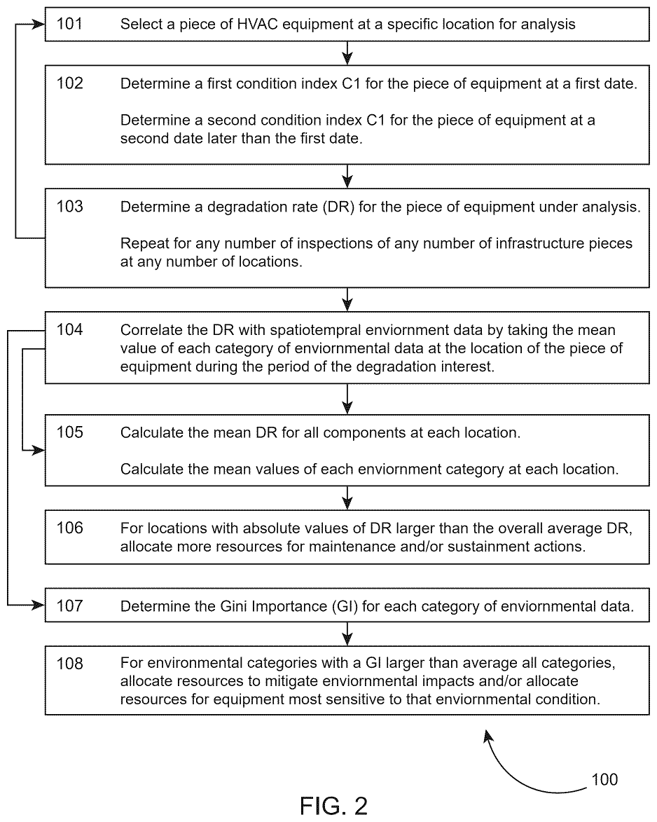

Referring to FIG. 2, the method 100 comprises a first step 101 of selecting one or HVAC components A1 . . . nn for analysis. The component may be at the same or different locations A, B. A degradation rate for each component under consideration and the lookback environmental data are then paired.

The second step 102 is to determine the condition index for each component at a time certain. The terms condition index and inspection score are used interchangeably herein. The condition index is based upon the procedure set forth in Grussing 2012 (Grussing, Micheal S. (2012). ERDC/CERL TR 12-13. Facility Degradation and Prediction Models for Sustainment, Restoration, and Modernization (SRM) Planning, available at: Grussing 2012 (Grussing, Micheal S. (2012). ERDC/CERL TR 12-13. Facility Degradation and Prediction Models for Sustainment, Restoration, and Modernization (SRM) Planning, available at: ERDC_CERL-TR-12-13-Facility-Degradation-and-Prediction-Models-for-Sustainment-Restoration-and-Modernization-SRM-Plannin.pdf—Downloads/ROOFER-SMS Helpdesk, incorporated herein by reference. One or more maintenance personnel evaluate a particular component using this procedure on a particular date designated T1 and determine the condition index designated CI1. The same person or persons evaluate the same component at a date designated T2 at least 30 days after T1. The condition index on date T2 is designated C2.

The next step 103 quantifies a degradation rate for each component by computing degradation rate as the change in condition over time for each specific component. Degradation rate is rate determined by the formula:

$$DR = ( CI 2 - CI 1 ) / ( T 2 - T 1 ) . \qquad Eq . 1$$

where DR is a degradation rate taken as percentage per month, CI1 is a condition index of an initial inspection, CI2 is a condition index of a later inspection, T2-T1 is the number of days between the initial inspection and the later inspection. T2−T1 is always taken over a period of 30 days or more, to avoid basing decisions on small changes over time and to avoid error sensitivity which occurs over short time periods. If desired Eq. 1 may be multiplied by 30 to normalize the DR to one month.

If there an HVAC component was twice inspected, there would be one inspection pair with the first inspection labeled as T1 and the second as T2. If there were three inspections done on an HVAC component, there would be two inspection pairs. The first inspection would be labeled as T1 and the second as T2 for the first inspection pair. The second inspection would also be labeled as T1 with the third labeled as T3 for the second inspection pair. Any number of inspections could be converted into inspection pairs following this method with the number of inspection pairs equal to the number of inspection pairs minus one. Equation 1 is then used to determine the degradation rate (DR) for each component under consideration.

The present invention does not directly consider slope. If there are three inspections, one of skill formulates the three inspections into two sets of initial-follow-on pairs at that location. Then keep all initial-follow-on inspection pairs are considered as independent observations, even if multiple datapoints come from the same piece of equipment.

The next step 104 is to correlate the degradation of a particular component with spatiotemporal environmental data, and optionally the mean value for each datum under consideration with the degradation of a particular component. The period of interest can be adjusted as helpful. Using the geographic location of each observation and the dates between each inspection in the large dataset, environmental effects to which the facility or infrastructure component were exposed are isolated. For example, an HVAC component is located at lat/long 29.42, −98.49 with inspections T1 on 1 Jan. 2023 and T2 on 1 Jan. 2024, and maximum daily precipitation is an environmental feature of interest. Maximum daily precipitation collected at 29.42, −98.49 each day from 1 Jan. 2023 to 1 Jan. 2024 would be associated with the DR for that component.

Following the correlation 104, one next step 105 is to calculate the mean degradation rate for all components per location and the mean value of each environmental factor from the daily environmental data associated with it in step 104. The following step 106 is to allocate resources to the locations having degradation rates which are statistically significantly greater than the mean. The resource allocation includes minor repair, major repair, complete overhaul and total replacement.

Following the correlation 104, another next step 107 is to calculate the Gini index for each category of environmental data. The following step is to allocate resources to mitigate environmental factors which have a greater Gini index than the mean and/or to mitigate effects for the most sensitive component. Such mitigation may include applying/restoring corrosion resistant coating, shading the component, adding cooling fans or radiators, insulating the component from cold weather or particular contaminants, etc.

The Gini indices are rank ordered from greatest to least. Resources may then be allocated towards the components having greater Gini indices.

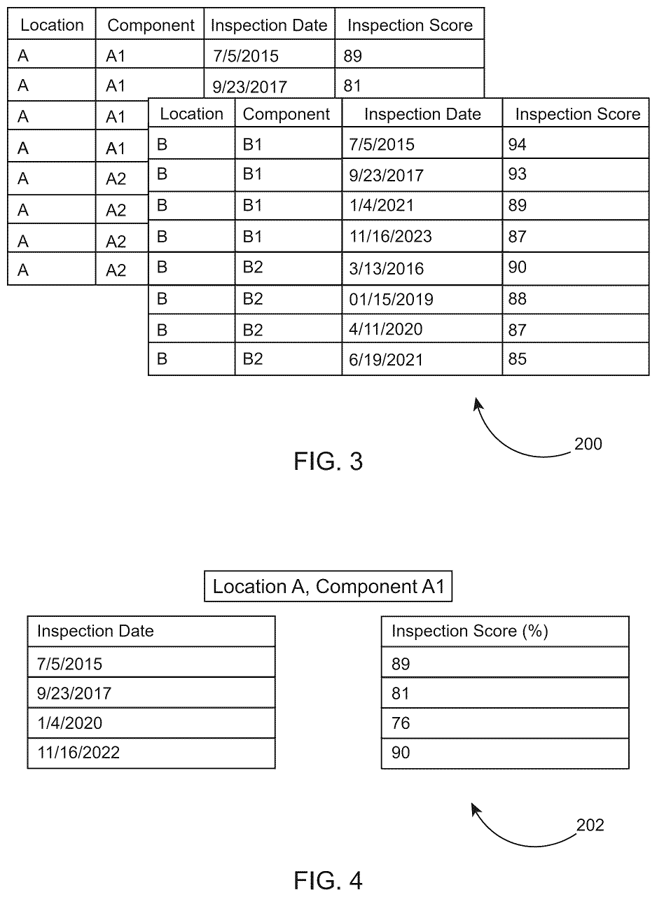

Referring to FIG. 3, and examining the invention in more detail by way of a nonlimiting example, another embodiment of the claimed method 200 is illustrated. In this embodiment of the method 200, a first step 201 is to complied data for two locations A, B. Two components A1, A2 for location A and two components B1, B2 for location B are considered. Initial inspection dates and initial condition indices CI1 for each component A1, A2, B1, B2 are complied.

Referring to FIG. 4, in the next step 202 the second inspection dates are established and correlated to the specific component A1, A2, B1, B2. The initial condition indices CI1 are maintained.

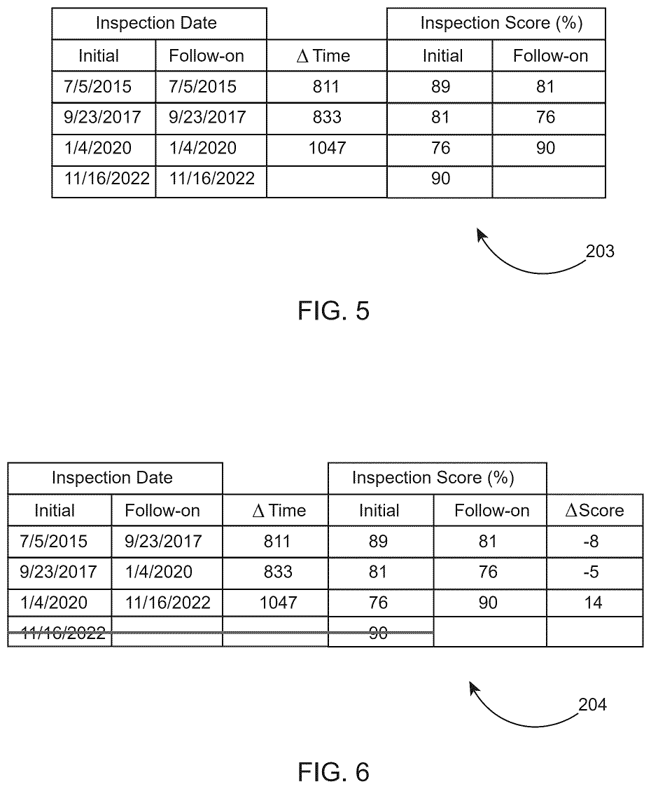

Referring to FIG. 5, in the next step 203 follow-on dates and follow-on condition indices CI2, where available, are compiled for each component A1, A2, B1, B2. The number of days (T2−T1) between the two inspection dates are calculated.

Referring to FIG. 6, in the next step 204 the data are redacted for component B2 which does not have a second inspection. There is no time difference for this datum point and it is discarded. The last inspection data are redacted since there is no follow-on inspection.

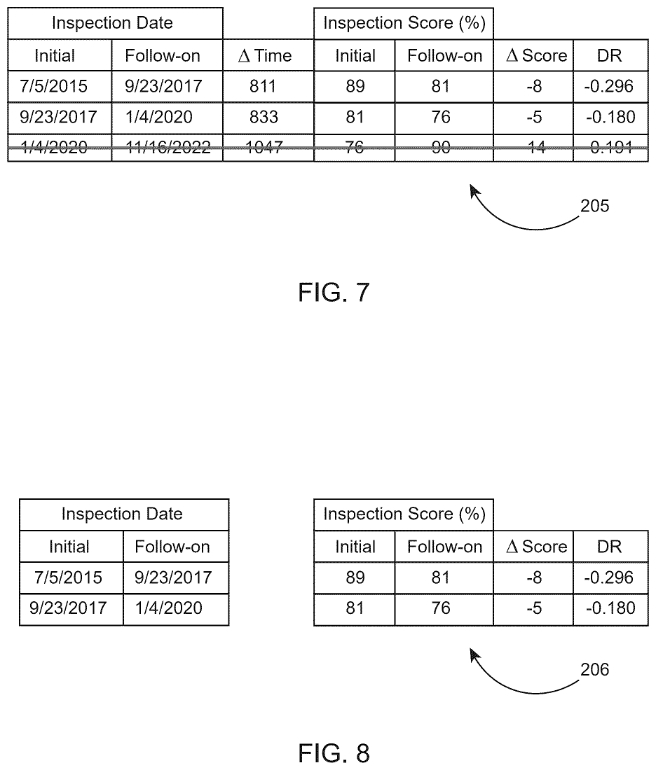

Referring to FIG. 7, in the next step 205 the data for component B1 which has an improved condition index over time is redacted and discarded. The basis for redacting such data is that remediation/replacement of that component B1 may have occurred or there may be an erroneous inspection yielding a false condition index CI1, CI2.

Referring to FIG. 8, in the next step 206, the degradation rates for the remaining component A1s, A2 are calculated according to Eq. 1. The respective degradation rate is then paired with the corresponding component A1, A2.

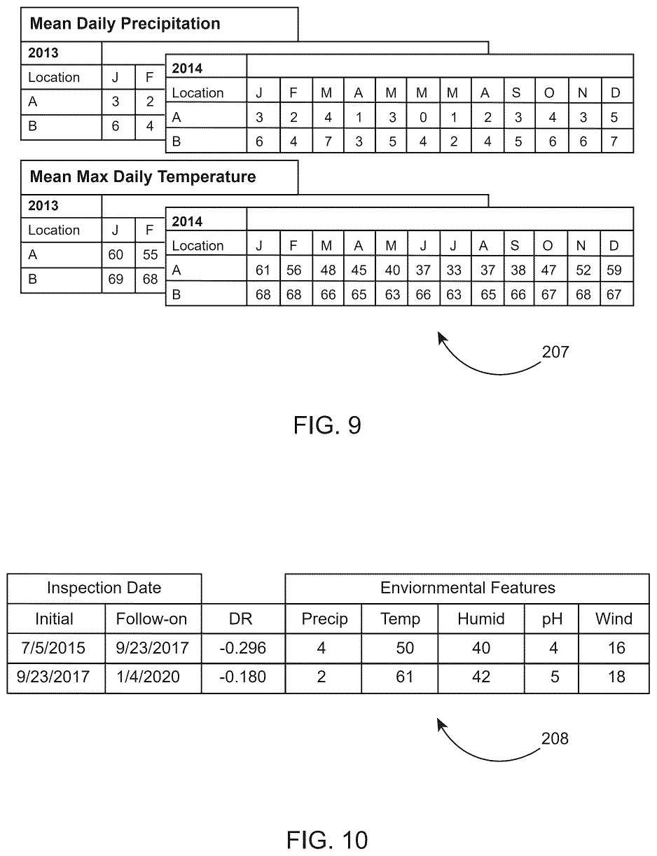

Referring to FIG. 9, in the next step 207, exemplary precipitation and daily maximum temperature data are compiled for each location. It is desirable to include one or more environmental factors having effects which can be mitigated. Exemplary such environmental factors include pH, wind speed, the number of freeze-thaw cycles, minimum temperature, etc.

Referring to FIG. 10, in the next step 208 the environmental data are compiled with the degradation rates. Exemplary precipitation, temperature, humidity, pH and wind speed are shown and paired to the specific location(s) A.

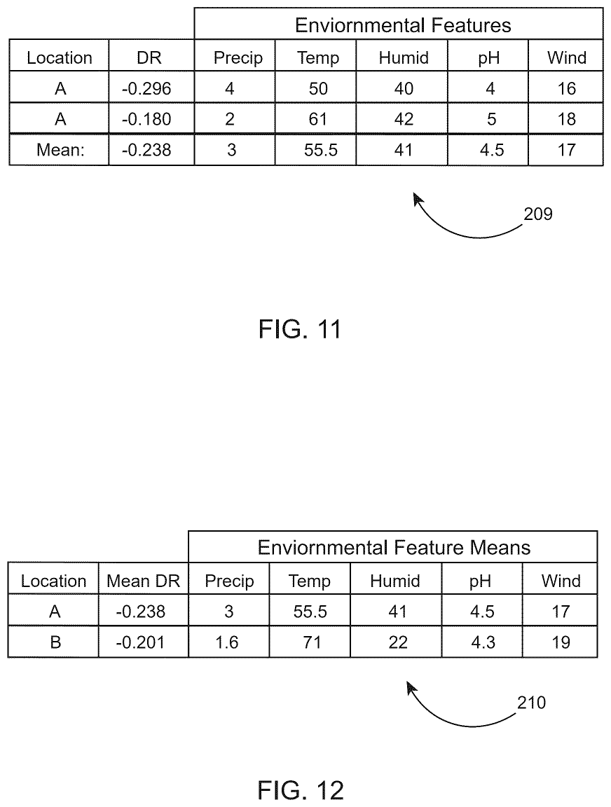

Referring to FIG. 11, in the next step 209 the mean degradation rate is calculated for the location(s) A. The mean for each environmental factor is also calculated.

Referring to FIG. 12, in the next step 210 corresponding data for another location B may be included. These data are also provided as a mean.

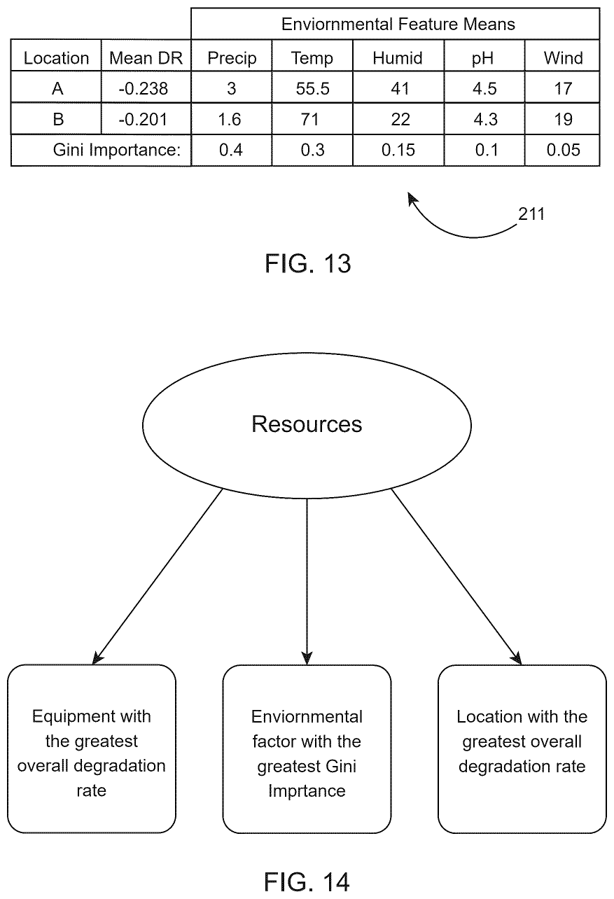

Referring to FIG. 13, in the next step 211 the Gini index is calculated for each environmental factor. The Gini index for is then calculated for each environmental factor according to the formula:

The GI estimates each feature's contribution to a predictive model. A random forest is made from many decision trees. While each decision tree is constructed, the fitting algorithm selects a feature and a value for that feature about which to split the data. The algorithm compares the mean squared error (MSE) of the model both before and after the split. The reduction in MSE is then attributed to the respective feature. The aggregate reduction in MSE constitutes the GI for each feature, which is normalized for each tree and averaged across all trees in the forest to determine the GI. The GI cannot be used to infer a positive or inverse relationship, however. For a given model, the GI for each feature represents the portion of the total mean squared error that was reduced by it. The GI values for all features sum to one, accounting for the total explanatory power of the model.

For a tree model using a set of features f₁ to f_{N}, each branch will choose a feature on which to split, fₙ. The Gini index for the particular feature GI(fₙ) is recalculated as:

$$GI ( {f}_{n} ) = GI ( {f}_{n} ) + ( M S {E}_{p a r e n t} - {MSE}_{left child} - {MSE}_{right child} ) \qquad Eq . 2$$

wherein the MSEs are the mean squared error of the training data before a split is calculated for fₙ. The child MSEs are the mean squared error on the training data for the resulting splits of fₙ.

The cumulative Gini index for a given factor, GI(fₙ) is then:

$$GI ( fn ) = {\sum }_{trees} {\sum }_{splits on fn} MSE parent - MSE left child - MSE right child \qquad Eq . 3$$

For convenience, the Gini index for all f may be normalized to sum to one:

$${GI ( fj )}_{N o r m a l i z e d} = \frac{GI ( fj )}{{\sum }_{n = 1}^{N} GI ( fn )} . \qquad Eq . 4$$

Referring to FIG. 14, the next step 212 is allocation of resources. Resources may include direct sustainment (preventative maintenance), restoration (repair of the HVAC unit when it breaks), and modernization (upgrade the system to new technology).

In this nonlimiting example, precipitation has the largest Gini index (0.4). This Gini index is the principal factor to be considered for resource allocation. For example, in one embodiment resources may be allocated to precipitation mitigation. HVAC components located at a location with higher precipitation may be prioritized to receive sustainment resources. Such resources may include temporary shelter such as a roof or canopy, improved drainage, weatherproof covers, etc.

Mitigating measures may be applied to reduce environmental effects from the environmental feature with the highest Gini index. Within a given location, HVAC components of a type with the largest mean DR may receive more sustainment resources than components that have lower CIs.

In another embodiment, resources may be allocated to location A, which has an 18.4% greater degradation rate (0.238/0.201) than location B. Such resource allocation may be improved training at location A, adding maintenance personnel at location A, increasing the frequency of preventative maintenance at location A, etc. If precipitation is the principal factor to be considered for resource allocation due to the highest Gini index and DR differs between locations, the location with the higher DR may be prioritized to receive sustainment funds which are then used to mitigate effects of precipitation.

Quantitatively, if the net present values of HVAC components at location A and location B are equal, a feasible allocation is for location A to receive 0.238/(0.238+0.201)=54.2% of sustainment funds while location B receives 0.201/(0.238+0.201)=45.8%. As location A receives more money proportionately than location B and interventions are installed to limit exposure to precipitation, the degradation rates would likely respond over time. It follows that allocation of sustainment funds over time would alter as well.

If net present value of HVAC components differs between locations, sustainment funds may again be scaled such that the location with more net value receives proportionately more funds than the other location. For example, location A contains 10% more HVAC components than location B by net present value and $1M is available for annual sustainment, location A may be allocated 54.2%×11/10×$1M=$596,200 and location B may be allocated the remaining $403,800.

In another embodiment, HVAC components of a certain type across one location or all locations may be grouped together and the mean DR computed. Resources may be allocated to that component type before other component types. In this example, there may be economies of scale realized if consistent maintenance or mitigating measures are applied across all components of a certain type.

In another embodiment, resources may be allocated to one component of a certain type that has a lower CI than another component. With degradation rates and environmental exposure information, a machine learning algorithm, such as Extreme Gradient Boosting, creates a model that can predict degradation rate given initial conditions and geographic location. Extreme Gradient Boosting employs a gradient boosting framework to iteratively add decision trees to an ensemble, each one aimed at correcting the errors of the previous trees. The model minimizes a loss function using gradient descent while incorporating a regularization term to prevent overfitting. This model results in a robust output while addressing many entangled, diverse, and non-linear interactions between the forces of environment acting upon the degrading component. Subsets of the model can be created from a curated sample of the training set for more specific functions, e.g., to predict only degradation of heating components of heating, ventilation, and air conditioning systems or to predict only degradation of infrastructure within a certain geographic region.

In another embodiment, resources may be allocated to component A1 which has a 64.4% greater degradation rate than (0.296/0.180) component A2. Such resource allocation may include more frequent preventative maintenance, overhaul, replacement, etc.

All values disclosed herein are not strictly limited to the exact numerical values recited. Unless otherwise specified, each such dimension is intended to mean both the recited value and a functionally equivalent range surrounding that value. For example, a dimension disclosed as “40 mm” is intended to mean “about 40 mm.” The term “or” as used herein is to be interpreted as an inclusive or meaning any one or any combination. Therefore, “A, B or C” means “any of the following: A; B; C; A and B; A and C; B and C; A, B and C.” Every document cited herein, including any cross referenced or related patent or application, is hereby incorporated herein by reference in its entirety unless expressly excluded or otherwise limited. The citation of any document or commercially available equipment is not an admission that such document or equipment is prior art with respect to any invention disclosed or claimed herein or that alone, or in any combination with any other document or equipment, teaches, suggests or discloses any such invention. Further, to the extent that any meaning or definition of a term in this document conflicts with any meaning or definition of the same term in a document incorporated by reference, the meaning or definition assigned to that term in this document shall govern according to Phillips v. AWH Corp., 415 F.3d 1303 (Fed. Cir. 2005). All limits shown herein as defining a range may be used with any other limit defining a range of that same parameter. That is the upper limit of one range may be used with the lower limit of another range for the same parameter, and vice versa. As used herein, when two components are joined or connected the components may be interchangeably contiguously joined together or connected with an intervening element therebetween. A component joined to the distal end of another component may be juxtaposed with or joined at the distal end thereof. While particular embodiments of the present invention have been illustrated and described, it would be obvious to those skilled in the art that various other changes and modifications can be made without departing from the spirit and scope of the invention and that various embodiments described herein may be used in any combination or combinations. It is therefore intended the appended claims cover all such changes and modifications that are within the scope of this invention.

What is claimed is:

1. A method of allocating resources for infrastructure sustainment, the method comprising the steps of:
a) assembling initial infrastructure condition information for a plurality of HVAC components;
b) calculating an infrastructure degradation rate for each component of the plurality of HVAC components;
c) associating the infrastructure degradation rate with respective spatiotemporal environmental data;
d) determining at least one environmental factor related to an infrastructure degradation under consideration;
e) determining a Gini index for each HVAC component; and
f) rank ordering the Gini indices to determine a priority for allocating the resources for infrastructure sustainment.

2. A method according to claim 1 wherein the infrastructure condition information for a predetermined component is selected from the group consisting of a respective condition index, one or more inspection dates and the geographic location thereof.

3. A method according to claim 2 wherein the condition index for the plurality of HVAC components considers at least one of rust, noise and vibrations.

4. A method according to claim 2 wherein condition information for the predetermined component does not include condition information which improves over time.

5. A method according to claim 1 wherein at least one degradation rate is given by the formula: DR=(CI2−CI1)/(T2−T1)
wherein DR is a degradation rate, CI1 is a condition index of an initial inspection, CI2 is a condition index of a later inspection, T2−T1 is the number of days between the initial inspection and the later inspection.

6. A method according to claim 5 further comprising the step of correlating the infrastructure degradation rate with at least one spatiotemporal environmental datum for a predetermined component.

7. A method according to claim 6 further comprising the step of outputting a dataset that includes a degradation rate, a location, and at least one environmental feature associated with a location and inspection dates of the predetermined component.

8. A method according to claim 7 wherein the Gini index is determined using a Gradient Boost algorithm.

9. A method according to claim 7 wherein the Gini index is determined using a Random Forest algorithm.

10. A method according to claim 1 further wherein the algorithm provides a rank order of a plurality of spatiotemporal environmental data as to the effect of each datum of the plurality spatiotemporal environmental data on the predetermined component.

11. A method according to claim 10 further comprising the step of allocating sustainment resources to the at least one HVAC component at a location where the mean DR is higher than at other locations.
